(19) United States
(12) Patent Application Publication
(10) Pub. No.: US 2013/0030906 A1
(43) Pub. Date: Jan. 31, 2013

(54) METHOD AND APPARATUS FOR PROVIDING A SERVICE IN ACCORDANCE WITH THE VIEWING OF AN ADVERTISEMENT USING DRM

(71) Applicants: Sung-Oh Hwang, Yongin-si (KR); Sergey Nikolayevich Seleznev, Suwon-si (KR)

(72) Inventors: Sung-Oh Hwang, Yongin-si (KR); Sergey Nikolayevich Seleznev, Suwon-si (KR)

(21) Appl. No.: 13/638,960

(22) PCT Filed: Apr. 1, 2011
(86) PCT No.: PCT/KR2011/002291

§ 371 Date: Oct. 2, 2012

(30) Foreign Application Priority Data
Apr. 2, 2010 (KR) 10-2010-0030617
May 4, 2010 (KR) 10-2010-0042162

(51) Int. Cl. G06Q 30/02

(52) U.S. Cl. 705/14.41

(57) ABSTRACT

Methods and apparatus for providing a multimedia service are provided. A first request message is transmitted from the device to a rights issuer requesting a first right object required to execute an advertisement. A first request response message having the first right object is transmitted from the rights issuer to the device. The advertisement is executed at the device using the first right object. A report message having an advertisement consumption specification is transmitted from the device based on execution of the advertisement. A report response message having an advertisement consumption certificate is received at the device. A second request message is transmitted from the device to the rights issuer requesting a second right object required to execute the content. A second request response message having the second right object is transmitted from the rights issuer to the device, when the second request message includes the advertisement consumption certificate.

### PRIORITY

This application is a National Phase Entry of PCT International Application No. PCT/KR2011/002291, which was filed on Apr. 1, 2011, and claims priority to Korean Patent Application Nos. 10-2010-0030617 and 10-2010-0042162 filed in the Korean Intellectual Property Office on Apr. 2, 2010 and May 4, 2010, respectively, the contents of which are incorporated herein by reference.

### BACKGROUND OF THE INVENTION

1. Field of the Invention

The present invention relates generally to advertisement services, and more particularly, to a method and apparatus for providing a main service according to whether an advertisement was executed.

2. Description of the Related Art

Multimedia services may be provided to a user at a lower price by providing contents together with advertisements. This promotes consumption of multimedia services, such as, for example, broadcast services or on-demand content delivery services. When a user uses a multimedia service at a lower price by executing an advertisement, a method of ensuring that the user executes the advertisement is required. A scheme for smoothly connecting a result of whether the advertisement was executed to the use of an actual service is also required at the service provider.

High-priced multimedia services or contents are usually protected with Digital Rights Management (DRM) and are occasionally provided along with advertisements to reduce consumption costs of the multimedia services or contents. The service provider may provide the high-priced multimedia services or contents at reduced costs depending on whether the advertisement was executed.

### SUMMARY OF THE INVENTION

The present invention has been made to address at least the above problems and/or disadvantages and to provide at least the advantages described below. Accordingly, an aspect of the present invention provides a method and apparatus for providing a service provider with a result of whether an advertisement was executed.

Another aspect of the present invention provides a method and apparatus for enabling a user to use a main service at a lower cost based on whether an advertisement was executed.

In accordance with an aspect of the present invention, a method of providing a multimedia service in a device is provided. Content and at least one advertisement are received. The content an the at least one advertisement correspond to the multimedia service. A first request message is transmitted that requests a first right object required to execute the at least one advertisement. Upon receiving a request response message having the first right object, the at least one advertisement is executed using the first right object. A report message having an advertisement consumption specification is transmitted based on execution of the at least one advertisement. A report response message having an advertisement consumption certificate is received, in response to the report message. A second request message is transmitted that requests a second right object required to execute the content. The second right object is obtained in response to the second request message. The second request message includes information related to the advertisement consumption certificate.

In accordance with another aspect of the present invention, a user device for providing a multimedia service is provided. The user device includes a multimedia player for executing content and at least one advertisement provided with the multimedia service. The user device also includes an agent for transmitting a first request message that requests a first right object required to execute the at least one advertisement upon receiving the content and the at least one advertisement, wherein the content and the at lest one advertisement correspond to the multimedia service, having the multimedia player execute the at least one advertisement using the first right object upon receiving a request response message having the first right object, transmitting a report message having an advertisement consumption specification based on execution of the at least one advertisement, receiving a report response message having an advertisement consumption certificate in response to the report message, transmitting a second request message that requests a second right object required to execute the content, and obtaining the second right in response to the second request message. The second request message includes information related to the advertisement consumption certificate.

In accordance with an additional aspect of the present invention, a method is provided for providing a multimedia service via advertisement execution in a rights issuer for issuing rights for content provided with the multimedia service. A first request message requesting a first right object required to execute at least one advertisement is received from a device. A first request response message having the first right object is transmitted to the device. A second request message requesting a second right object required to execute content associated with the at least one advertisement, is received from the device. The second right object is generated, when the second request message includes information related to an advertisement consumption certificate authenticating that the device executed the at least one advertisement. A second request response message having the second right object is transmitted to the device.

In accordance with a further aspect of the present invention, a rights issuer for issuing a right for content provided with a multimedia service is provided. The rights issuer includes a communication unit for transmitting and receiving messages to and from a device. The rights issuer also includes a rights manager for receiving, from the device, a first request message requesting a first right object required to execute at least one advertisement, transmitting, to the device, a first request response message having the first right object, receiving, from the device, a second request message requesting a second right object required to execute content associated with the at least one advertisement, generating the second right object when the second request message includes information related to an advertisement consumption certificate authenticating that the device executed the at least one advertisement, and transmitting, to the device, a second request response message having the second right object.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a block diagram illustrating a service system, according to an embodiment of the present invention;

FIG. 2 is a block diagram illustrating a user device, according to an embodiment of the present invention;

FIG. 3 is a block diagram illustrating a rights issuer, according to an embodiment of the present invention;

FIG. 4 is a structure of a right request message, according to an embodiment of the present invention;

FIG. 5 is a structure of a right request response message, according to an embodiment of the present invention;

FIG. 6 is a structure of an advertisement consumption measuring report, according to an embodiment of the present invention;

FIG. 7 is a structure of a token report message, according to an embodiment of the present invention;

FIG. 8 is a diagram illustrating operations between the user device and the rights issuer, according to an embodiment of the present invention;

FIG. 9 is a structure of the right request response message, according to another embodiment of the present invention; and

FIGS. 10 and 11 are diagrams illustrating operations among the user device, the rights issuer, and an advertisement server, according to another embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

The invention may be embodied in many different forms and should not be construed as being limited to the embodiments set forth herein. The embodiments of the present invention are provided for a thorough and complete disclosure, and will fully convey the concept of the present invention to those skilled in the art.

The detailed description presents representative embodiments of the present invention in order to achieve the foregoing technological objectives. For convenience of explaining the present invention, terminologies of technologies and entities defined by the Open Mobile Alliance (OMA) Digital Right Management (DRM) will be used as they are, but do not limit the scope of the present invention.

According to an embodiment of the present invention, a service provider provides a main service together with an advertisement and ensures that a user executes the advertisement, thereby allowing the user to use the main service at a lower cost. Specifically, by using the DRM technology used in multimedia services or content protection, the service provider allows the user to use the main service based on whether the user executed an advertisement. As used herein, an advertisement may be executed when it is displayed, viewed, watched and/or consumed, for example.

When the user subscribes to a multimedia service provided with one or more advertisements, a user device requests and obtains, from a network entity, a right or an authority to use the advertisement to be executed before using the multimedia service. The user device whether the advertisement was executed, is given the right to use the multimedia service when the advertisement was executed, and executes the multimedia service.

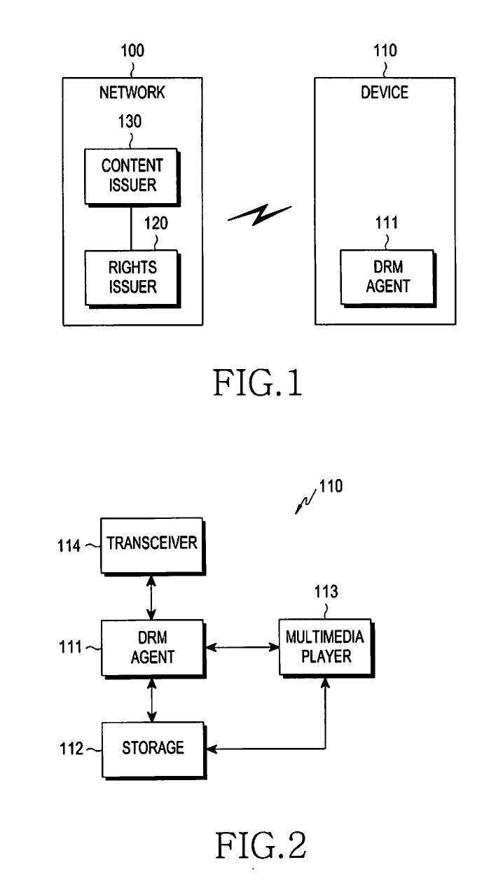

FIG. 1 is a diagram illustrating a service system using DRM, according to an embodiment of the present invention, in which there are entities engaged in providing a DRM protected advertisement-based multimedia service. A network 100 includes a rights issuer 120 and a content issuer 130. A device 110 requesting and executing a particular service includes a DRM agent 111, a display for outputting the advertisement, and a controller for controlling advertisement output and general operations of the device 110.

The network 100 is in an area of an operator or content provider that provides multimedia services or contents and an advertisement provider that provides advertisements. The device 110 is in an area of a user who executes the multimedia services or contents and executes the advertisements.

The content issuer 130 is a server device that provides multimedia services to the device 110. The content issuer 130 is provided contents from the content provider and is provided advertisements from the advertisement provider. In an embodiment of the present invention, the content issuer 130 provides a device with a multimedia service and an associated advertisement in response to a request from the device. Content to be provided with the requested multimedia service and the associated advertisement may be combined into a service package and then provided to the device.

The rights issuer 120 is a server device for generating and managing Right Objects (ROs) that represent rights to use, for example, various services, contents, and advertisements, provided by the content issuer 130. The rights issuer 120 authenticates and registers a device that will execute an RO, and transmits the RO at the request of the device. The rights issuer 120 also monitors if content of interest is executed as established by the RO, and is given a report of the present state of the content execution from the device that requested the RO.

In an embodiment of the present invention, the rights issuer 120 and the content issuer 130 generate ROs associated with service packages in which contents and advertisements are combined, under an agreement. In an embodiment of the present invention, a content consumable RO and an advertisement consumable RO are assumed to be separate ROs, and the content consumable RO is assumed to be delivered after advertisement execution.

Specifically, in an embodiment of the present invention, in response to a request from a device, the rights issuer 130 transmits a first RO, which corresponds to a certain advertisement, to the device. If a request for a second RO associated with the certain advertisement is received from the device, the rights issuer 120 delivers the second RO to the device after determining from an advertisement consumption certificate that the device played the certain advertisement.

The advertisement consumption certificate is information for authenticating that the device executed the certain advertisement. The advertisement consumption certificate may be consumption authenticating information that represents only the fact of the consumption, or a token that represents an amount of the advertisement consumption, according to an embodiment of the present invention. The advertisement consumption certificate may be issued by the rights issuer 120 or by a separate advertisement server for managing an advertisement consumption specification, according to an embodiment of the present invention.

When the rights issuer 120 issues the advertisement consumption certificate, and a report on the execution of the certain advertisement is received, the rights issuer 120 delivers the advertisement consumption certificate to the device after confirming of the advertisement execution.

The device 110 requests a certain multimedia service or content from the content issuer 130, and obtains, from the rights issuer 120, an RO for executing the requested multimedia service. The device 110 executes the multimedia service or content, using the obtained RO.

The device 110 requests a certain multimedia service, according to an embodiment of the present invention. When receiving a service package corresponding to the multimedia service from the content issuer 130, the device 110 requests, from the rights issuer 120, an RO for an advertisement contained in the service package. When receiving the RO for the advertisement from the rights issuer 120, the device 110 plays the advertisement by using the RO. Upon completing the reproduction of the advertisement, the device 110 reports the advertisement consumption specification to the rights issuer 120 or to an advertisement server, according to an embodiment of the present invention, and obtains the advertisement consumption certificate.

The device then requests an RO for content contained in the service package from the rights issuer 120. The device 110 puts the advertisement consumption certificate into the RO request message and transmits the message to the rights issuer 120. Upon receiving the RO for the content from the rights issuer 120, the device 110 may play the content by using the RO.

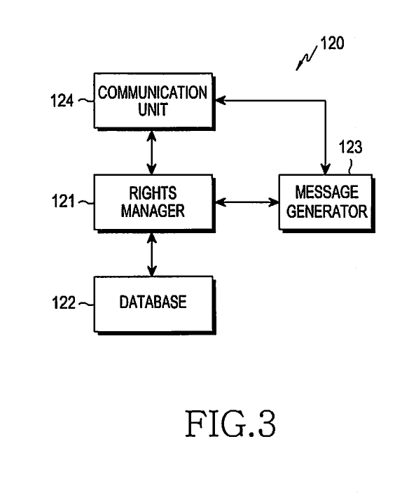

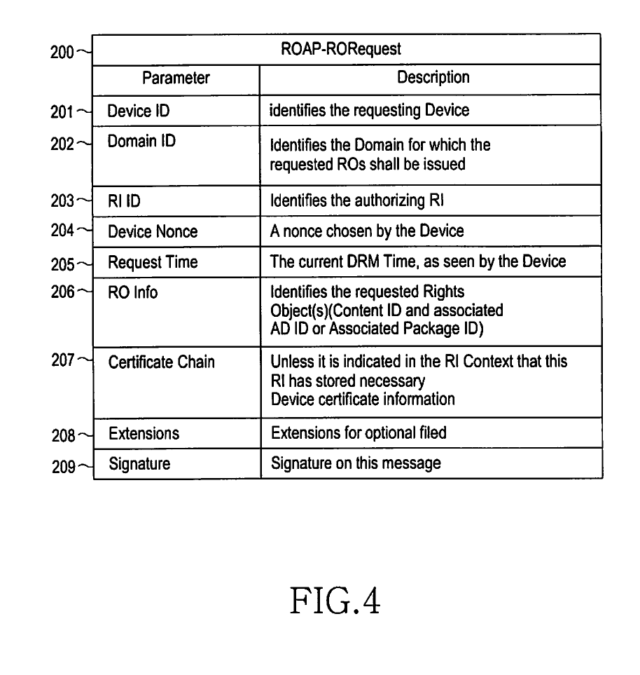

Examples of the device 110 and the rights issuer 120 that operate as discussed above are shown in FIGS. 2 and 3. FIG. 2 is a block diagram illustrating the device 110, according to an embodiment of the present invention. FIG. 3 is a diagram illustrating the rights issuer 120, according to an embodiment of the present invention.

Referring to FIG. 2, the device 110 includes a DRM agent 111, a storage 112, a multimedia player 113, and a transceiver 114.

The multimedia player 113 plays the content and the advertisement received with a multimedia service, under the control of the DRM agent 111.

The storage 112 stores programs for controlling the device 110, reference data, many different updatable data for storage, etc. The storage 112 provides these items to a working memory of the DRM agent 111. The storage 112 stores various contents and advertisements received with multimedia services.

The transceiver 114 transmits and receives messages and data to and from a network entity, delivers received messages and data to the DRM agent 111, and transmits to the network entity messages and data delivered from the DRM agent 111.

The DRM agent 111 is a software component for controlling an operation to apply DRM in executing DRM content. Thus, the DRM agent 111 performs operations related to a multimedia service request, RO obtainment required for executing the requested multimedia service, and application of the obtained RO. The DRM agent 111 controls operations of each of the associated components of the device 110, and processes and generates associated messages.

Referring to FIG. 3, the rights issuer 120 includes a rights manager 121, a database 122, a message generator 123, and a communication unit 124.

The communication unit 124 transmits and receives messages or data to and from network entities or devices, delivers received messages or data to the rights manager 121, and transmits messages and data delivered from the right manager 121 and the message generator 123 to a corresponding network entity or device.

The database 122 stores various information required for generating ROs, e.g., device authentication information, and information about authorities for various contents and advertisements. The database 122 stores information related to the advertisement consumption certificate.

The message generator 123 generates many different messages under the control of the rights manager 121, and delivers these messages to the communication unit 124.

The rights manager 121 performs authentication for a device that requests an RO, and operations related to generation, delivery, processing of ROs for various contents and advertisements. The rights manager 121 also controls each of the associated components of the rights issuer 120. The rights manager 121 performs operations required for generation and identification of the advertisement consumption certificate, and controls each of the associated components of the rights issuer 120. Specifically, the rights manager 121 performs various operations associated with generation, delivery and processing of ROs, and generation or identification of the advertisement consumption certificate, according to an embodiment of the present invention.

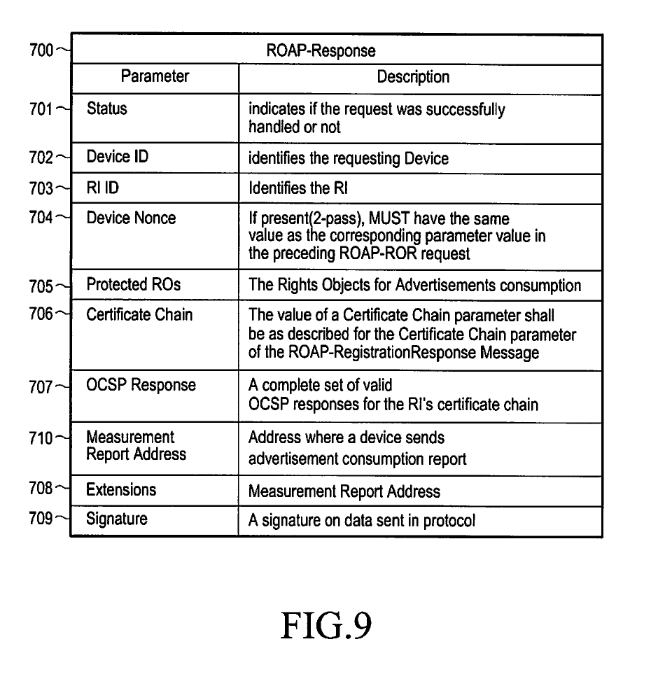

A procedure of providing a multimedia service according to an embodiment of the present invention is described below, with reference to FIG. 8. FIG. 8 shows operations between the device 110 and the rights issuer 120, according to an embodiment of the present invention. In FIG. 8, DRM messages that are not directly related to the description of the present invention are omitted.

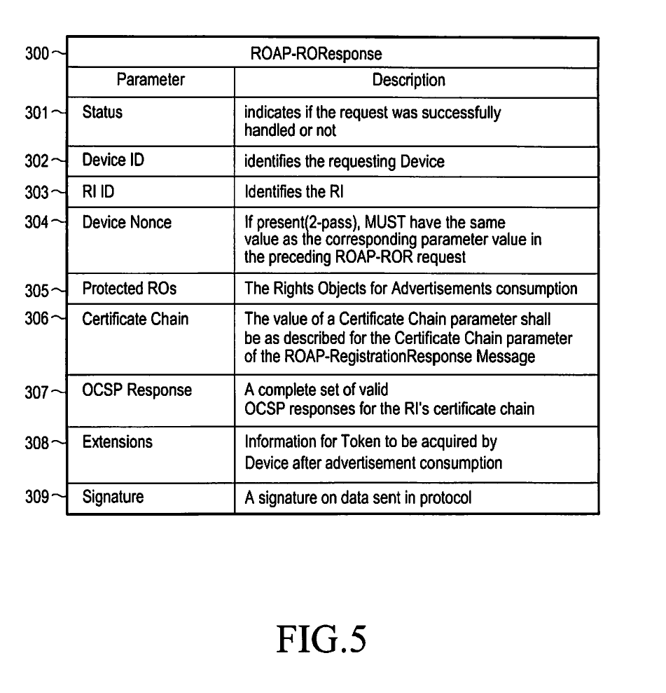

Referring to FIG. 8, the device 110 requests a certain multimedia service from the content issuer 130, and in return, receives a service package corresponding to the multimedia service. The device 110 identifies the service package in which an advertisement and multimedia content are combined. In step 601, the device 110 transmits an RO request message, e.g., an Right Object Acquisition Protocol Right Object Request (ROAP-RORequest) message, to the rights issuer 120 in order to obtain an RO that enables the device to execute the advertisement contained in the service package. An example of the ROAP-RORequest message is shown in FIG. 4.

Parameters shown in FIG. 4 are specified in OMA DRM version 2.

A ROAP-RORequest message 200 is used when the device 110 requests an RO that defines an encryption key for certain content and authority to execute the content. Referring to FIG. 4, the ROAP-RORequest message 200 includes a Device IDentifier (ID) field 201, a Domain ID field 202, an Rights Issuer (RI) ID field 203, a Device Nonce field 204, a Request Time field 205, an RO Info field 206, a Certificate Chain field 207, an Extensions field 208, and a Signature field 209.

A difference between a conventional ROAP-RORequest message and the ROAP-RORequest message 200, according to an embodiment of the present invention, lies in what is stored in the RO Info field 206. The RO Info field 206 is where information for designating an RO that is desired to be obtained, is stored. A conventional RO Info field has to include identification information of a certain content to be executed by the device 110, and thus, the RO corresponding to the content is bound to be requested. On the contrary, the RO Info field 206 of an embodiment of the present invention may designate an RO desired to be obtained by storing identification information of a certain content and identification information of an advertisement related to the content, and identification information of a service package in which the content and the advertisement are combined.

What is stored in the RO Info field 206 depends on how the service provider informs a user of information about content combined with an advertisement. For example, if a content identifier is contained in the RO Info filed 206 but the ROAP-RORequest message 200 includes no advertisement consumption certificate, the rights issuer 120 searches for advertisements to be executed before using the content and transmits an RO for the advertisement to the user device.

If the RO Info field 206 includes an advertisement identifier, the rights issuer 120 generates an RO that corresponds to the advertisement identifier and transmits the RO to the device 110. The rights issuer 120 determines which content is to be provided after execution of the advertisement that corresponds to the advertisement identifier, and transmits an RO related to the content when the device 110 of the user requests the RO after advertisement execution.

If the RO Info filed 206 includes a package identifier, the rights issuer 120 provides an RO enabling execution of the advertisement contained in the package indicated by the package identifier.

The device ID field 201 of FIG. 4 has a device ID, which is an identifier of the device 110 transmitting the ROAP-RORequest message 200. The domain ID field 202 has a domain ID, which is an identifier of a domain if the device 110 belongs to the domain. ‘Domain’ is a concept used in OMA DRM, meaning a set of devices owned by a user, and the user may request an RO to execute certain content in all devices within the domain.

The RI ID field 203 has an RI ID, which is an identifier of the rights issuer 120 that will receive the ROAP-RORequest message 200. The Device Nonce field 204 has an encrypted value to authenticate the device 110. The Request Time field 205 has a time stamp of when the ROAP-RORequest message 200 is transmitted. The Certificate Chain field 207 has information about a highest authentication agency that authenticates the device 110. The Extensions field 208 has content in addition to the main content of the message, e.g., the advertisement consumption certificate. The Signature field 209 has a description to authenticate integrity and security of the ROAP-RORequest message 200.

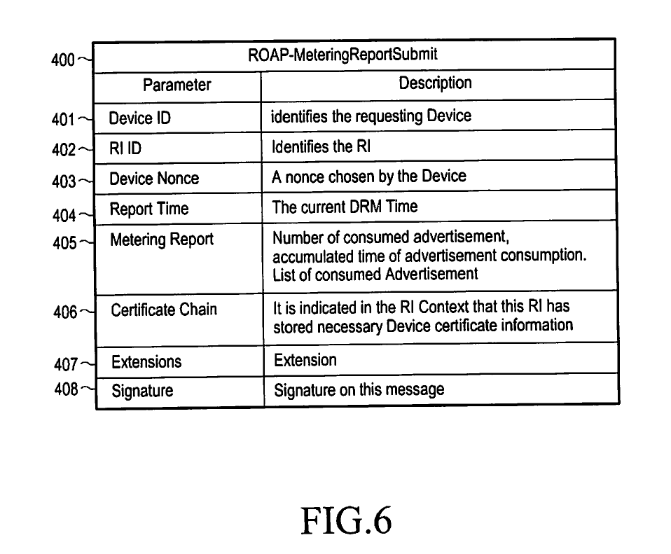

Referring back to FIG. 8, after receiving the ROAP-RORequest message 200, as described in connection with FIG. 4, the rights issuer 120 examines the received ROAP-RORequest. If it is determined that the ROAP-RORequest is a proper request, the rights issuer 120 transmits an RO request-response message, e.g., an ROAP-ROResponse message, in step 603. An example of the ROAP-ROResponse message is shown in FIG. 5.

A ROAP-ROResponse message 300 of FIG. 5 is a message indicating the result of processing the RO requested by the device 100. The ROAP-ROResponse message includes a Status field 301, a Device ID field 302, an RI ID field 303, a Device Nonce Field 304, a Protected ROs field 305, a Certificate Chain field 306, an Online Certificate Status Protocol (OCSP) Response field 307, an Extensions field 308, and a Signature field 309.

The rights issuer 120 sends a rejection message by describing the reason in the Status field 301, if the request of the device 110 using the ROAP-RORequest message 200 is not appropriate. The rights issuer 120 sends the RO requested by the device 110 if the request is appropriate.

Descriptions and functions of information included in the Device ID field 302, the RI ID field 303, the Device Nonce Field 304, the Signature field 309 of FIG. 3 are similar to those of the Device ID field 202, the RI ID field 203, the Device Nonce Field 204, and the Signature field 209 of FIG. 2.

The Protected ROs field 305 includes an RO encrypted with an encryption key that only the device 110 may open. The Protected ROs field also includes, in step 603 of FIG. 8, an RO containing information for advertisement reproduction.

The Certificate Chain field 306 includes information verified by the rights issuer 120 from the highest authentication agency with certificate chain information provided by the device 110, using the Certificate Chain field 207 of FIG. 2.

When using a token as the advertisement consumption certificate, the Extensions field 308 has information about the token that may be provided by the rights issuer 120 after advertisement execution. The information to be included in the Extensions field 308 depends on how the rights issuer 120 will provide the content after the device 110 executes the advertisement.

For example, if a right to use the content is given immediately after the device 110 executed the number of advertisements as defined in the RO provided in the Protected ROs field 305, the Extensions field 308 does not need to have any extra information. On the contrary, if the rights issuer 120 issues a kind of token as a result of executing the advertisement for the device 110 to use the token to use the content, the Extensions field 308 may store an amount of the token that will be provided after executing the advertisement. Furthermore, the Extensions field 308 may specify a place to store the token, such as at the device 110 or the rights issuer 120, or if an amount of the token for each advertisement is different, the amount of the token may be stored in the Extensions field. If the amount of the token varies with advertisement execution time, information about the token variation may be provided by the Extensions field 308. Token provision policy may be made by the service provider.

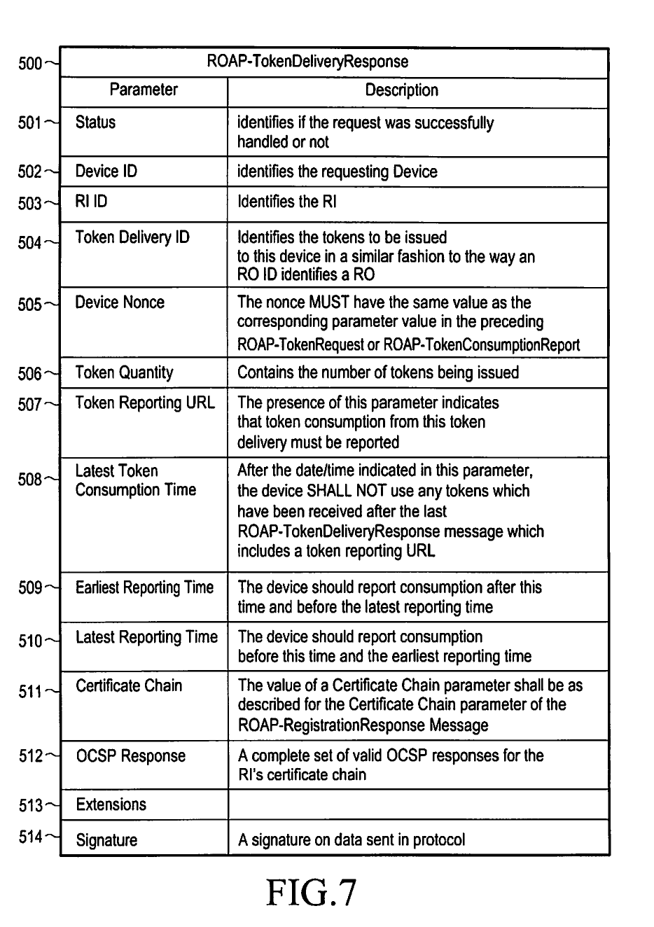

Referring back to FIG. 8, after executing the advertisement indicated by the ROAP-RORespone message received in step 603, the device 110 reports the result of the advertisement execution by sending an advertisement consumption report message, e.g., Reporting Report Submit message, to the rights issuer 120, in step 605. An example of the Reporting Report submit message is shown in FIG. 6.

Referring to FIG. 6, a Reporting Report Submit message 400 includes a Device ID field 401, an RI ID field 402, a Device Nonce field 403, a Report Time field 404, a Metering Report field 405, a Certificate Chain field 406, an Extensions field 407, and a Signature field 408.

The Reporting Report Submit message 400 shown in FIG. 6 is obtained by enhancing an ROAP-MeteringReportSubmit message defined by OMA DRM for the purpose of embodiments of the present invention. The Device ID field 401, the RI ID field 402, the Device Nonce field 403, the Report Time field 404, the Certificate Chain field 406, the Extensions field 407, and the Signature field 408 of FIG. 6 serve the same roles as those having the same names in connection with FIG. 4.

The Metering Report field 405 may include information about the number of executed advertisements, total advertisement execution time, a list of executed advertisements, etc. Information to be included in the Metering Report field 405 depends on what is contained in the RO transmitted in the Protected RO field 305 and in the Extensions field 308 of FIG. 5.

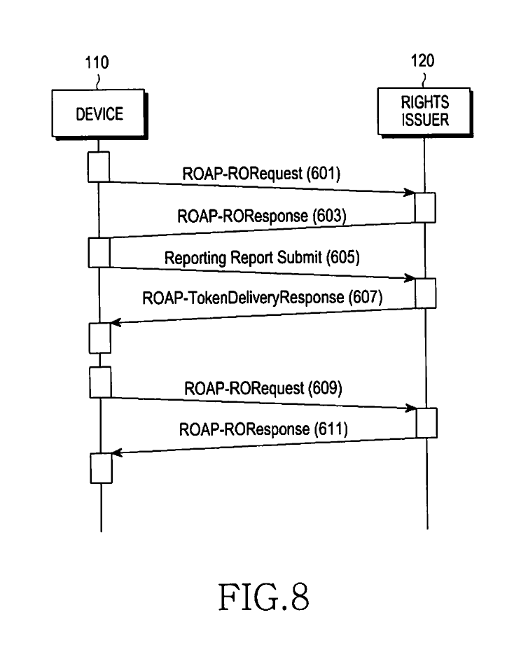

In the foregoing descriptions of FIG. 8, it is assumed that the result of the advertisement execution is provided by the token. However, if the result of the advertisement execution is not provided by the token, the device 110 may just report a fact of completed advertisement execution. After determining from the Reporting Report Submit message 400 received in step 605 that the device 110 played all the requested advertisements, the rights issuer 120 transmits an advertisement consumption report response message, e.g., ROAP-TokenDeliveryResponse message to the device 110, in step 607. An example of the ROAP-TokenDeliveryResponse message is shown in FIG. 7, which has a similar structure and role to an ROAP-TokenDeliveryResponse message of OMA DRM 2.0 extension for BCAST.

Referring to FIG. 7, a ROAP-TokenDeliveryResponse message 500 includes a Status field 501, a Device ID field 502, an RI ID field 503, a Token Delivery ID field 504, a Device Nonce Field 505, a Token Quantity field 506, a Token Reporting URL field 507, a Latest Token Consumption field 508, an Earliest Reporting Time field 509, a Latest Reporting Time field 510, a Certificate Chain field 511, an OCSP Response field 512, an Extensions field 513, and a Signature field 514.

The Status field 501 is a field that indicates the result of processing the Reporting Report Submit message in step 605. The Device ID field 502 is a field where an identifier of the device is stored. The RI ID field 503 is a field where an identifier of the rights issuer 120 that issued the token is stored. The Token Delivery ID field 504 includes an identifier of the issued token.

The Device Nonce field 505 has information needed to authenticate the device. The Token Quantity field 506 is a field that indicates the number of issued tokens. The Token Reporting URL field 507 has an address of a place to which a result of using the token is reported. The Latest Token Consumption field 508 is a field that indicates a period during which the token is valid. The Earliest Reporting Time field 509 and the Latest Reporting Time field 510 include information about a period within which the device has to report a token consumption state.

The Certificate Chain field 511 contains information regarding the highest authentication agency. The OCSP Response field 512 contains a response to the certificate chain of the rights issuer 120. The Extensions field 513 and the Signature field 514 serve the same roles as other fields with the same names in FIGS. 4-6.

In the foregoing description, the case of using the token as the advertisement consumption certificate was taken as an example, however in the case of using consumption authentication information as the advertisement consumption certificate, the advertisement consumption report response message may include an identifier of the consumption authentication information, a time period for which the consumption authentication information is valid, etc. Specifically, the advertisement consumption response message includes identification information of the consumption certificate and the time period for which the consumption authentication is valid, to indicate that the device 110 has right to obtain an RO for the content.

After receiving the ROAP-TokenDeliveryResponse message 500 in step 607, the device 110 requests the RO for the content desired to be played by a user by transmitting an RO request message, i.e., ROAP-RORequest message, to the rights issuer 120, in step 609. The RO request message includes the identifier of the content corresponding to the desired RO, and information about the advertisement consumption certificate.

Upon receiving the ROAP-RORequest message in step 609, the rights issuer 120 checks the token or the advertisement consumption certificate included in the ROP-RORequest message, to determine if the device is entitled to obtain the RO for the corresponding content. If the device is entitled to obtain the RO, the rights issuer 120 delivers the ROAP-ROResponse message including the requested RO to the device 110. The ROAP-RORequest message of step 609 and the ROAP-ROResponse message of step 611 may be configured to be similar to the ROAP-RORequest message and the ROAP-ROResponse message, shown in FIGS. 4 and 5, respectively.

Upon receiving the ROAP-ROResponse message, the device 110 may play the corresponding content by using the RO included in the ROAP-ROResponse message.

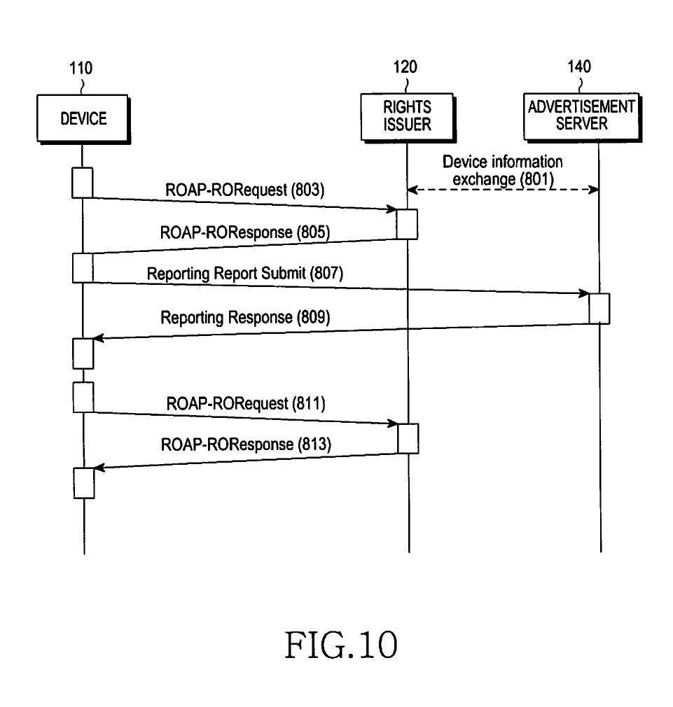

In the foregoing embodiment of the present invention, the rights issuer 120 checks the advertisement consumption specification of the device 110 and issues the advertisement consumption certificate. However, the issuance of the advertisement consumption specification of the device 110 and the advertisement consumption certificate may be performed by a separate server device. FIGS. 9 to 11 are diagrams representing other embodiments of the present invention.

In another embodiments of the present invention, it is assumed that a business entity that provides content in return for advertisement execution is not the same as the rights issuer 120 that provides an RO for advertisement execution. Specifically, after a third party makes a business agreement with the owner of the rights issuer 120 that provides the RO to the device 110, the third party provides suitable content to the device 110 according to the result of the device's advertisement execution. The device 110 reports the advertisement consumption specification, not to the rights issuer 120, but to the third party's server. The third party's server may be different from the rights issuer 120 of a business entity that owns the rights issuer 120. Hereinafter, a server to which the device 110 has to report the advertisement consumption specification will be referred to as an advertisement server, according to an embodiment of the present invention.

FIG. 9 shows an example of the RO response message configured for the rights issuer 120, for transmission of the RO in response to the RO request for advertisement execution. In this embodiment of the present invention, an ROAP response message 700 includes an address of the server device to which the device 110 has to report the advertisement consumption specification after executing the advertisement, i.e., an address of the advertisement server.

Referring to FIG. 9, the ROAP response message 700 includes a Status field 701, a Device ID field 702, an RI ID field 703, a Device Nonce field 704, a Protected ROs field 705, a Certificate Chain field 706, an OCSP Response field 707, an Extensions field 708, a Signature field 709, and a Measurement Report Address field 710.

The Device ID field 702, the RI ID field 703, the Device Nonce field 704, the Protected ROs field 705, the Certificate Chain field 706, the OCSP Response field 707, and the Signature field 709 of FIG. 9 serve the same roles as those of the Device ID field 302, the RI ID field 303, the Device Nonce field 304, the Protected ROs field 305, the Certificate Chain field 306, the OCSP Response field 307, and the Signature field 309 of FIG. 5.

The Measurement Report Address field 710 of FIG. 9 has an address of the server to which the device 110 has to report the advertisement consumption specification after executing the advertisement, and a URL may be used as the address of the server.

The Extensions field 708 is provided for when the Measurement Report Address field 710 does not exist as an independent element but is given a valid value depending on whether there is a value in the Extensions field 708. Specifically, if the Measurement Report Address field 710 has a valid address value, the Extensions field 708 does not have any address value; and if the Measurement Address field 710 does not have any address value, then the Extensions field 708 has a valid address value.

In this embodiment of the present invention, the reporting of advertisement consumption measurement may be conducted by using the ROAP-Metering-Report message 400, which is illustrated in FIG. 6. It is assumed that the information contained in the Device ID field 401, the RI DI field 402, the Device Nonce field 403, the Certificate Chain field 406 is information of which the rights issuer 120, transmitting the ROAP Response message 700 shown in FIG. 9, and the advertisement server, which is to receive the advertisement consumption report message, mutually know via a prior information exchange. There are numerous ways of information exchange between the rights issuer 120 and the advertisement server.

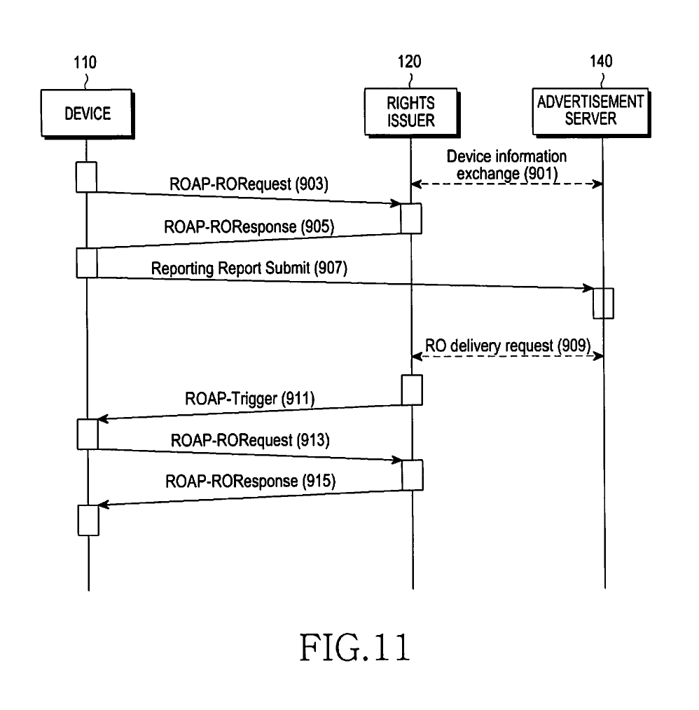

FIGS. 10 and 11 are flowcharts of operations among entities, according to other embodiments of the present invention. Specifically, procedures of operations among the device 110, which executes content after advertisement execution, the rights issuer 120, which manages the RO for the content execution, and the advertisement server 140, which determines whether to provide content by determining the advertisement consumption specification, are shown.

Referring to FIG. 10, the rights issuer 120 and the advertisement server 140 exchange information related to the device 110 in advance, in step 801.

The device 110 requests, from the rights issuer 120, an RO for enabling execution of an advertisement or advertisements connected to a certain content by using the ROAP-RORequest message.

In return, the rights issuer 120 sends the ROAP-ROResponse message 700, in step 805. The structure and operation of the ROAP-ROResponse message shown in FIG. 9 includes an address of the advertisement server 140 for reporting the advertisement consumption specification, according to an embodiment of the present invention.

The device 110 reports the advertisement consumption specification to the advertisement server 140 with the Reporting Report Submit message, in step 807, after executing a certain number of advertisements. The Reporting Report Submit message may be configured as shown in FIG. 6.

The advertisement server 140 transmits the advertisement consumption report response message to the device 110 directly, as shown in FIG. 10, or via the rights issuer 120, as shown in FIG. 11, after receiving the advertisement consumption report message from the device 120.

In FIG. 10, upon receiving the Reporting Report Submit message in step 807, the advertisement server 140 checks the advertisement consumption specification included in the received Reporting Report Submit message, and generates the advertisement consumption certificate. The advertisement server 140 configures the advertisement consumption report response message, e.g., the Reporting Response message including information related to the advertisement consumption certificate, and transmits the message to the device 110, in step 809. The advertisement consumption certificate may be consumption certificate information or may be a token.

After receiving the Reporting Response message, the device 110 transmits, to the rights issuer 120, the ROAP-RORequest message to request the RO for content execution in step 811. The ROAP-RORequest message includes information about the advertisement consumption certificate sent in the Reporting Response message.

The rights issuer 120 identifies the information about the advertisement consumption certificate of the ROAP-RORequest message received in step 811. If the information is appropriate, the rights issuer 120 generates an RO requested by the device 110 and delivers the RO to the device 110, using the ROAP-ROResponse message, in step 813.

Upon receiving the ROAP-ROResponse message, the device 110 may play the corresponding content by using the RO included in the ROAP-ROResponse message.

Transmission of the advertisement consumption report response message from the advertisement server 140 to the device 110 through the rights issuer 120 is described with reference to FIG. 11.

In FIG. 11, steps 901 to 907 are identical to steps 801 to 807 of FIG. 10. In step 907, the advertisement server 140 receives the Reporting Report Submit message, checks the advertisement consumption specification included in the received message, and generates the consumption certificate. The advertisement server 140 configures the advertisement consumption report response message, e.g., the RO Delivery Request message including information related to the advertisement consumption certificate, and transmits the message to the rights issuer 120, in step 909. The RO delivery Request message is a message requesting that the rights issuer 840 to deliver the RO to the device 110.

Upon receiving the RO Delivery Request message, the rights issuer 120 configures a ROAP-Trigger message to have information related to the advertisement consumption certificate, and delivers the ROAP-Trigger message to the device 110, in step 911.

The device 110 receives the ROAP-Trigger message and transmits, to the rights issuer 120, the ROAP-RORequest message to request the RO for content execution, in step 913. The ROAP-RORequest message includes information about the advertisement consumption certificate sent in the ROAP-Trigger message.

The rights issuer 120 identifies the information about the advertisement consumption certificate of the ROAP-RORequest message received in step 913. If the information is appropriate, the rights issuer 120 generates the RO requested by the device 110 and delivers the RO to the device 110, using the ROAP-ROResponse message, in step 915.

Upon receiving the ROAP-ROResponse message, the device 110 may play the corresponding content by using the RO included in the ROAP-ROResponse message.

While the invention has been shown and described with reference to certain embodiments thereof, it will be under stood by those skilled in the art that various changes in form and detail may be made therein without departing from the spirit and scope of the invention as defined by the appended claims. For example, the rights issuer 120 and the content issuer 130 have been described as separate servers in the foregoing descriptions, but they may be integrated into a single server. Specifically, a service-providing server may be configured to include the content issuer and the rights issuer. Thus, it will be apparent to those ordinary skilled in the art that the invention is not limited to the embodiments described, and can encompass not only the appended claims but also their equivalents.

1. A method of providing a multimedia service in a device, the method comprising the steps of:
receiving content and at least one advertisement, wherein the content an the at least one advertisement correspond the multimedia service
transmitting a first request message that requests a first right object required to execute the at least one advertisement;
upon receiving a request response message having the first right object, executing the at least one advertisement using the first right object;
transmitting a report message having an advertisement consumption specification based on execution of the at least one advertisement;
receiving a report response message having an advertisement consumption certificate, in response to the report message;
transmitting a second request message that requests a second right object required to execute the content;
obtaining the second right object in response to the second request message,
wherein the second request message comprises information related to the advertisement consumption certificate.

2. The method of claim 1, wherein the report message is transmitted to a rights issuer that generates the first right object and the second right objects.

3. The method of claim 1, wherein the report message is transmitted to an advertisement server and the report response message is received from the advertisement server, when the advertisement server, which manages an advertisement consumption specification, is designated to receive the report message for the request response message.

4. The method of claim 1, wherein the advertisement consumption certificate comprises information authenticating that the advertisement has been executed.

5. The method of claim 1, wherein the advertisement consumption specification comprises identification information of at least one of the at least one advertisement that has been executed, a number of executed advertisements, and a total execution time.

6. The method of claim 1, wherein the advertisement I consumption certificate is a token issued based on an amount of advertisement execution,
wherein the request response message comprises information about a token to be generated in advertisement execution, and
wherein the report response message comprises information about the token generated due to execution of the at least one advertisement.

7. A user device for providing a multimedia service, the user device comprising:
a multimedia player for executing content and at least one advertisement provided with the multimedia service; and
an agent for transmitting a first request message that requests a first right object required to execute the at least one advertisement upon receiving the content and the at least one advertisement, wherein the content and the at least one advertisement correspond to the multimedia service, having the multimedia player execute the at least one advertisement using the first right object upon receiving a request response message having the first right object, transmitting a report message having an advertisement consumption specification based on execution of the at least one advertisement, receiving a report response message having an advertisement consumption certificate in response to the report message, transmitting a second request message that requests a second right object required to execute the content, and obtaining the second right in response to the second request message,
wherein the second request message comprises information related to the advertisement consumption certificate.

8. The user device of claim 7, wherein the report message is transmitted to a rights issuer that generates the first right object and the second right objects.

9. The user device of claim 7, wherein the report message is transmitted to an advertisement server and the report response message is received from the advertisement server, when the advertisement server, which manages an advertisement consumption specification, is designated to receive the report message for the request response message.

10. The user device of claim 7, wherein the advertisement consumption certificate comprises information authenticating that the at least one advertisement has been executed at the user device.

11. The user device of claim 7, wherein the advertisement consumption specification comprises identification information of at least one of the at least one advertisement that has been executed, a number of executed advertisements, and a total execution time.

12. The user device of claim 7, wherein the advertisement consumption certificate is a token issued based on an amount of advertisement execution,
wherein the request response message comprises information about a token to be generated in advertisement execution, and
wherein the report response message comprises information about the token generated due to execution of the at least one advertisement.

13. A method of providing a multimedia service via advertisement execution in a rights issuer for issuing rights for content provided with the multimedia service, the method comprising the steps of:
receiving, from a device, a first request message requesting a first right object required to execute at least one advertisement;
transmitting, to the device, a first request response message having the first right object;
receiving, from the device, a second request message requesting a second right object required to execute content associated with the at least one advertisement;
generating the second right object, when the second request message comprises information related to an advertisement consumption certificate authenticating that the device executed the at least one advertisement; and
transmitting, to the device, a second request response message having the second right object.

14. The method of claim 13, further comprising
receiving, from the device, a report message having a consumption specification of the at least one advertisement; and
generating the advertisement consumption certificate corresponding to the consumption specification, and transmitting, to the device, a report response message having the advertisement consumption certificate.

15. The method of claim 14, wherein the advertisement consumption specification comprises identification information of at least one of the at least one advertisement that has been executed, a number of executed advertisements, and a total execution time.

16. The method of claim 14, wherein the advertisement consumption certificate is a token issued based on an amount of advertisement execution,
wherein the first request response message comprises information about a token to be generated in advertisement execution, and
wherein the report response message comprises information about the token generated due to execution of the at least one advertisement.

17. The method of claim 13, further comprising,
delivering the advertisement consumption certificate to the device. upon receiving a message having the advertisement consumption certificate from an advertisement server for managing an advertisement consumption specification.

18. A rights issuer for issuing a right for content provided with a multimedia services, the rights issuer comprising:
a communication unit for transmitting and receiving messages to and from a device; and
a rights manager for receiving, from the device, a first request message requesting a first right object required to execute at least one advertisement, transmitting, to the device, a first request response message having the first right object, receiving, from the device, a second request message requesting a second right object required to execute content associated with the at least one advertisement, generating the second right object when the second request message comprises information related to an advertisement consumption certificate authenticating that the device executed the at least one advertisement, and transmitting, to the device, a second request response message having the second right object.

19. The rights issuer of claim 18, wherein the rights manager receives, from the device, a report message having a consumption specification of the at least one advertisement, generates the advertisement consumption certificate corresponding to the consumption specification, and transmits, to the device, a report response message having the advertisement consumption certificate.

20. The rights issuer of claim 19, wherein the advertisement consumption specification comprises identification information of at least one of the at least one advertisement that has been executed, a number of executed advertisements, and a total execution time.

21. The rights issuer of claim 19, wherein the advertisement consumption certificate is a token issued based on an amount of advertisement execution,
wherein the first request response message comprises information about a token to be generated in advertisement execution, and
wherein the report response message comprises information about the token generated due to execution of the at least one advertisement.

22. The rights issuer of claim 18, wherein the rights manager delivers the advertisement consumption certificate to the device, upon receiving a message having the advertisement consumption certificate from an advertisement server for managing an advertisement consumption specification.
